(19) United States
(12) Patent Application Publication
(10) Pub. No.: US 2020/0225619 A1
(43) Pub. Date: Jul. 16, 2020

(54) STATOR, STEPPING MOTOR, TIMEPIECE MOVEMENT, TIMEPIECE, AND MANUFACTURING METHOD OF STATOR

(71) Applicant: Seiko Instruments Inc,., Chiba-shi, (JP)

(72) Inventors: Kosuke YAMAMOTO, Chiba-shi (JP); Shinji KINOSHITA, Chiba-shi (JP); Ryosuke ISOGAI, Chiba-shi (JP)

(21) Appl. No.: 16/734,873

(22) Filed: Jan. 6, 2020

(30) Foreign Application Priority Data
Jan. 11, 2019 (JP) 2019-003669
Aug. 23, 2019 (JP) 2019-153131

(51) Int. Cl. G04C 3/14; H02K 37/14; H02K 1/02; H02K 15/02

(52) U.S. Cl. CPC G04C 3/143; H02K 37/14; G04C 10/00; H02K 15/02; H02K 1/02

(57) ABSTRACT

A stator includes a magnetic body having a through-hole, a magnetoresistive portion disposed around the through-hole to generate a magnetic pole around the through-hole in a case where a coil is excited, and a non-magnetic portion disposed at a position different from a position of the magnetoresistive portion around the through-hole by means of thermal melting, and formed to have lower magnetic permeability than the magnetic body.

### RELATED APPLICATIONS

This application claims priority to Japanese Patent Application No. 2019-003669 filed on Jan. 11, 2019, and 2019-153131 filed on Aug. 23, 2019, the entire content of which is incorporated herein by reference.

### BACKGROUND OF THE INVENTION

### 1. Field of the Invention

Embodiments of the present disclosure relates to a stator, a stepping motor, a timepiece movement, a timepiece, and a manufacturing method of a stator.

### 2. Description of the Related Art

In the related art, a timepiece is known which includes a stepping motor for rotationally driving an hour hand or a minute hand. The stepping motor has a rotatably arranged rotor, a stator having a through-hole formed to install the rotor, a magnetic core magnetically coupled to the stator, and a coil wound around the magnetic core. The stator has a positioning portion formed to determine a static position of the rotor.

In order to rotate the rotor, drive pulses having different polarities are alternately supplied to the coil from a drive circuit. Due to the supplied drive pulses, magnetic flux leakages having different polarities alternately occur in the stator. Due to the supplied drive pulses, the rotor is rotated every 180 degrees in a predetermined direction (positive direction), and stops at a position corresponding to the positioning portion.

In general, the stepping motor has a narrow portion having a narrowed width in two locations (interval of 180°) around the through-hole formed to install the rotor. In this manner, the stepping motor adopts an integrated stator in which a magnetic flux is likely to be saturated. According to this structure, the magnetic flux leakage for driving the rotor is likely to be obtained.

As the stator for easily obtain the magnetic flux leakage for driving the rotor, a so-called two-body type stator is known (for example, refer to JP-B-1993-56109). The stator is formed as follows. First, the stator is divided into two pieces by cutting the stator in the two locations (interval of 180°) around the through-hole where a cross-sectional area of a magnetic path is minimized. Next, a slit material made of a low magnetic permeability material or a non-magnetic material is inserted into the cut locations. Next, the slit material is welded and joined to the divided stator.

The stepping motor in the related art adopts a technique in which the through-hole of the stator is provided with a notch or step shape as the positioning portion. Since the through-hole of the stator is provided with the notch or step shape, a difference in magnetic potentials of the rotor is generated depending on a position (angle) of the rotor. In this manner, a holding torque acts on the rotor, and the static position of the rotor can be determined.

### SUMMARY OF THE INVENTION

Incidentally, in a case of a small timepiece, a mountable battery is small. Consequently, it is necessary to reduce power consumption required for driving the stepping motor by reducing the holding torque acting on the rotor. In a case where the through-hole of the stator is provided with the notch or step shape as the positioning portion, it is necessary to reduce the notch or step shape in order to reduce the holding torque acting on the rotor. However, machining in the related art has a limit in carrying out micromachining work. Therefore, the stepping motor in the related art has a disadvantage in that the holding torque acting on the rotor needs to be reduced.

Therefore, an object of the present disclosure is to provide a stator, a stepping motor, a timepiece movement, a timepiece, a manufacturing method of a stator, which can reduce a holding torque acting on a rotor.

According to the present disclosure, there is provided a stator including a magnetic body having a through-hole, a magnetoresistive portion disposed around the through-hole to generate a magnetic pole around the through-hole in a case where a coil is excited, and a non-magnetic portion disposed at a position different from a position of the magnetoresistive portion around the through-hole by means of thermal melting, and formed to have lower magnetic permeability than the magnetic body.

According to the present disclosure, the non-magnetic portion having the lower magnetic permeability than the magnetic body is disposed around the through-hole of the magnetic body. In this manner, without providing the through-hole with a notch or step shape, a difference in magnetic potentials of the rotor can be generated depending on a rotation position of the rotor. Therefore, the holding torque acting on the rotor can be adjusted by appropriately adjusting a shape, a size, or the magnetic permeability of the non-magnetic portion. Therefore, according to the stator of the present invention, the holding torque acting on the rotor can be reduced.

In the stator, the non-magnetic portion may be disposed on an inner peripheral surface of the through-hole.

According to the present disclosure, the non-magnetic portion can be disposed at a position directly facing the rotor. Therefore, the difference in the magnetic potentials of the rotor can be reliably generated depending on a rotation position of the rotor. Therefore, it is possible to prevent an insufficient holding torque acting on the rotor.

In the stator, the non-magnetic portion may be disposed away from the through-hole.

According to the present disclosure, the non-magnetic portion is disposed in a range affected by a magnetic field of the rotor, a difference in the magnetic potentials of the rotor can be generated depending on a rotation position of the rotor. Therefore, it is possible to provide the stator which can reduce the holding torque acting on the rotor.

In the stator, the non-magnetic portion may be disposed only in a portion of the through-hole in a penetrating direction.

According to the present disclosure, compared to a case where the non-magnetic portion is disposed over the entire region of the through-hole in the penetrating direction, a range where the non-magnetic portion is affected by the magnetic field of the rotor is reduced. In this manner, it is possible to reduce a difference in the magnetic potentials of the rotor depending on a rotation position of the rotor. That is, the holding torque acting on the rotor can be adjusted by appropriately adjusting the range having the non-magnetic portion in the penetrating direction of the through-hole.

In the stator, the non-magnetic portion may not penetrate the magnetic body.

According to the present disclosure, compared to a case where the non-magnetic portion penetrates the magnetic body, it is possible to reduce the range where the non-magnetic portion is affected by the magnetic field of the rotor. Therefore, a maximum value of the magnetic potential decreases in a relationship between the rotation position of the rotor and the magnetic potential. Therefore, it is possible to prevent the excessive holding force acting on the rotor.

In the stator, the magnetic body may include a Ni—Fe alloy, and the non-magnetic portion may be formed to have a higher Cr content rate than the magnetic body.

According to the present disclosure, the magnetic permeability of a non-magnetic region is reduced compared to the surrounding region by the non-magnetic region which is brought into an austenitic single phase having diffused Cr. Accordingly, it is possible to form the non-magnetic portion having the lower magnetic permeability than the magnetic body.

In the stator, the magnetoresistive portion may be formed by means of the thermal melting, and may be formed to have the lower magnetic permeability than the magnetic body and to have the higher Cr content rate than the magnetic body.

In the related art, in some cases, in order to generate the magnetic pole by magnetically dividing the stator, an interval from the through-hole to an outer edge of the stator is narrowed so that magnetic flux density saturation (magnetic saturation) is generated by the magnetic field of the coil. According to the present invention, the magnetic permeability of the magnetoresistive portion is reduced compared to the magnetic body by the non-magnetic region which is brought into the austenitic single phase having the diffused Cr. In this manner, the magnetic pole can be generated by using the magnetoresistive portion to magnetically divide the stator without adopting the related art.

In the stator, the magnetoresistive portion may be formed to reach a first depth from a first surface of the magnetic body, and the non-magnetic portion may be formed to reach a second depth different from the first depth from the first surface of the magnetic body.

In the present disclosure, the magnetoresistive portion and the non-magnetic portion are formed to have mutually different depths. Here, in order to prevent the magnetic flux required for the magnetic saturation when the magnetic pole is generated from being excessively generated, it is desirable to appropriately set the depth of the magnetoresistive portion. In order to prevent the excessive holding force acting on the rotor, it is desirable to appropriately set the depth of the non-magnetic portion. The magnetoresistive portion and the non-magnetic portion are formed to have the mutually different depths. In this manner, it is possible to prevent the excessive magnetic flux when the magnetic pole is generated, and to prevent the excessive holding force acting on the rotor. Therefore, it is possible to reduce a current flowing through the coil when the rotor is rotated.

In the stator, the second depth may be shallower than the first depth.

According to the present disclosure, while the depth of the non-magnetic portion is set in order to obtain a desired holding force acting on the rotor, compared to the non-magnetic portion, the magnetoresistive portion can be deeply formed to reduce the magnetic flux required for the magnetic saturation. Accordingly, it is possible to prevent the excessive magnetic flux when the magnetic pole is generated, and to prevent the excessive holding force acting on the rotor. Therefore, it is possible to reduce a current flowing through the coil when the rotor is rotated.

In the stator, the magnetoresistive portion may be formed to have the lower magnetic permeability than the magnetic body, and a minimum interval from the through-hole to an outer edge may be 0.1 mm or longer.

In the related art, in some cases, in order to generate the magnetic pole by magnetically dividing the stator, the interval from the through-hole to the outer edge of the stator is narrowed so that the magnetic flux density saturation is generated by the magnetic field of the coil. According to the present invention, the magnetic permeability of the magnetoresistive portion is reduced compared to the magnetic body. In this manner, the magnetic pole can be generated by using the magnetoresistive portion to magnetically divide the stator without adopting the related art. Accordingly, even if the minimum interval from the through-hole to the outer edge of the stator is set to 0.1 mm or longer, the magnetic pole can be generated by the magnetoresistive portion. Therefore, strength of the stator can be improved, compared to the related art.

According to the present disclosure, there is provided a stepping motor including the stator, and a rotor located in the through-hole.

According to the present disclosure, there is provided a timepiece movement including the stepping motor, and a train wheel that transmits power of the stepping motor.

According to the present disclosure, the timepiece movement includes the stator which can reduce the holding torque acting on the rotor. Therefore, it is possible to reduce the current flowing through the coil when the rotor is rotated. Therefore, it is possible to reduce power consumption.

According to the present disclosure, there is provided a timepiece including the timepiece movement.

According to the present disclosure, it is possible to provide the timepiece for which the power consumption is reduced. In particular, the present invention is preferably applicable to the timepiece having a small mountable battery.

According to the present disclosure, there is provided a manufacturing method of a stator including a magnetic body having a through-hole and including a Ni—Fe alloy, a magnetoresistive portion disposed around the through-hole to generate a magnetic pole around the through-hole in a case where a coil is excited, and a non-magnetic portion disposed at a position different from a position of the magnetoresistive portion around the through-hole, and formed to have lower magnetic permeability than the magnetic body. The manufacturing method includes locating a Cr material in a magnetic material, melting and solidifying the Cr material in the magnetic material by irradiating the Cr material with a laser, and forming the through-hole by punching the magnetic material after the Cr material is melted.

According to the present disclosure, the through-hole is formed after the Cr material is melted and solidified. Accordingly, it is possible to prevent thermal deformation of the through-hole. Therefore, the stator can be accurately formed.

In the manufacturing method of the stator, the chrome melting step includes a first irradiating step of forming at least a portion of the magnetoresistive portion by irradiating the Cr material with the laser, and a second irradiating step of forming at least a portion of the non-magnetic portion by irradiating the Cr material with the laser and applying energy lower than energy of the laser used in the first irradiating step.

According to the present disclosure, as the applied energy increases, a depth for melting and diffusing Cr increases. Accordingly, the non-magnetic portion can be formed to be shallower than the magnetoresistive portion. Therefore, while the excessive magnetic flux is prevented when the magnetic pole is generated around the magnetoresistive portion, it is possible to prevent the excessive holding force acting on the rotor. Therefore, it is possible to provide the stator which can reduce the current flowing through the coil when the rotor is rotated.

### BRIEF DESCRIPTION OF THE DRAWINGS

FIG. 1 is a block diagram illustrating a timepiece according to a first embodiment.

FIG. 2 is a perspective view illustrating a schematic configuration example of a stepping motor according to the first embodiment.

FIG. 3 is a plan view schematically illustrating the stepping motor according to the first embodiment.

FIG. 4 is a sectional view of a stator which is taken along line IV-IV in FIG. 3.

FIG. 5 is a flowchart illustrating a manufacturing method of the stator according to the first embodiment.

FIG. 6 is a schematic view for describing the manufacturing method of the stator according to the first embodiment.

FIG. 7 is a plan view schematically illustrating a stepping motor according to a second embodiment.

FIG. 8 is a sectional view of a stator which is taken along line VIII-VIII in FIG. 7.

FIG. 9 is a plan view schematically illustrating a stepping motor according to a third embodiment.

FIG. 10 is a plan view schematically illustrating a stepping motor according to a fourth embodiment.

FIGS. 11A and 11B are sectional views of a stator according to the fourth embodiment. FIG. 11A is a sectional view of a stator which is taken along line XIA-XIA in FIG. 10, and FIG. 11B is a sectional view of the stator which is taken along line XIB-XIB in FIG. 10.

FIG. 12 is a sectional view of a stator according to a modification example of the fourth embodiment, and is a view illustrating a cross section in a portion corresponding to line in FIG. 10.

FIG. 13 is a flowchart illustrating a manufacturing method of the stator according to the fourth embodiment.

### DETAILED DESCRIPTION OF THE PREFERRED EMBODIMENTS

Hereinafter, embodiments according to the present invention will be described with reference to the drawings. In the following description, the same reference numerals will be given to configurations having the same or similar functions. Repeated description of the configurations may be omitted in some cases. In the embodiments described below, an analog electronic timepiece will be described as an example of a timepiece.

### First Embodiment

### Timepiece and Movement

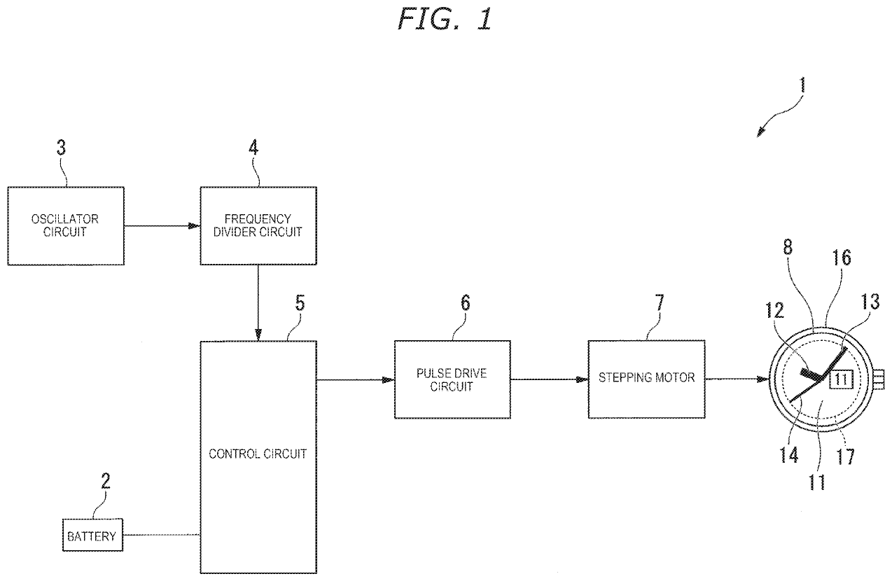

FIG. 1 is a block diagram illustrating a timepiece according to a first embodiment.

As illustrated in FIG. 1, a timepiece 1 includes a battery 2, an oscillator circuit 3, a frequency divider circuit 4, a control circuit 5, a pulse drive circuit 6, a stepping motor 7, and an analog timepiece unit 8.

The analog timepiece unit 8 includes a train wheel 11, an hour hand 12, a minute hand 13, a second hand 14, a calendar display unit 15, a timepiece case 16, and a movement 17 (timepiece movement). In the present embodiment, if one of the hour hand 12, the minute hand 13, and the second hand 14 is not specified, all of these will be referred to as “indicating hands”. The oscillator circuit 3, the frequency divider circuit 4, the control circuit 5, the pulse drive circuit 6, the stepping motor 7, and the train wheel 11 are configuration elements of the movement 17.

For example, the battery 2 is a so-called button battery such as a silver oxide battery and a lithium battery. The battery 2 may be a solar battery and a storage battery that stores power generated by the solar battery. The battery 2 supplies the power to the control circuit 5.

The oscillator circuit 3 is a passive element used for oscillating a predetermined frequency from a mechanical resonance thereof by utilizing a quartz piezoelectric phenomenon, for example. Here, the predetermined frequency is 32 kHz, for example.

The frequency divider circuit 4 divides a predetermined frequency signal output from the oscillator circuit 3 into a desired frequency, and outputs the divided signal to the control circuit 5.

The control circuit 5 measures the time by using the divided signal output from the frequency divider circuit 4, and generates a drive pulse, based on a result of the measured time. The control circuit 5 generates a forward rotating drive pulse in a case where the indicating hands are operated in a forward rotation direction. The control circuit 5 generates a rearward rotating drive pulse in a case where the indicating hands are operated in a rearward rotation direction. The control circuit 5 outputs the generated drive pulse to the pulse drive circuit 6.

The pulse drive circuit 6 generates the drive pulses for each of the indicating hands in accordance with drive instructions output from the control circuit 5. The pulse drive circuit 6 outputs the generated drive pulse to the stepping motor 7.

The stepping motor 7 operates the indicating hands in accordance with the drive pulse output from the pulse drive circuit 6. In the example illustrated in FIG. 1, for example, the stepping motor 7 is provided for each of the hour hand 12, the minute hand 13, and the second hand 14. Power of the stepping motor 7 is transmitted to the indicating hand by the train wheel 11.

The hour hand 12, the minute hand 13 and the second hand 14 are respectively driven by the power of the stepping motor 7. The hour hand 12 is rotated once in 12 hours by the pulse drive circuit 6 driving the stepping motor 7. The minute hand 13 is rotated once in 60 minutes by the pulse drive circuit 6 driving the stepping motor 7. The second hand 14 is rotated once in 60 seconds by the pulse drive circuit 6 driving the stepping motor 7.

### Configuration of Stepping Motor

### A Schematic Configuration of the Stepping Motor

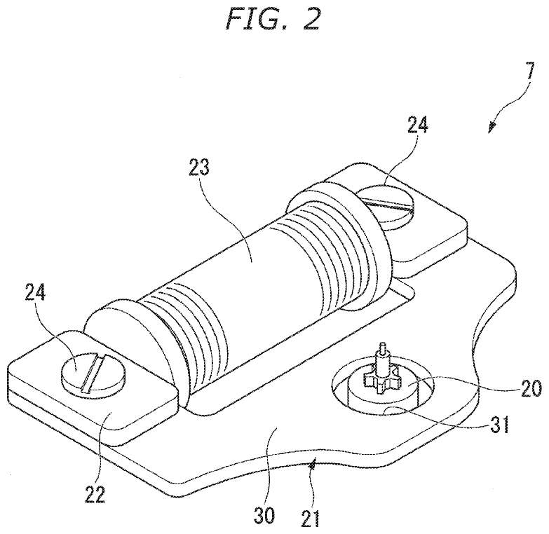

FIG. 2 is a perspective view illustrating a schematic configuration example of the stepping motor 7 according to the first embodiment.

As illustrated in FIG. 2, the stepping motor 7 includes a rotor 20 magnetized with two poles (S-pole and N-pole), a stator 21 that generates a magnetic pole facing the rotor 20, a magnetic core 22 magnetically coupled to the stator 21, a coil 23 wound around the magnetic core 22 to excite the stator 21, and a screw 24 joining the stator 21 and the magnetic core 22 to each other. The rotor 20 is rotatably supported by a ground plate configuring a substrate of the movement 17. The rotor 20 has a pinion that meshes with the train wheel 11.

Here, a configuration of the stator 21 will be described in detail.

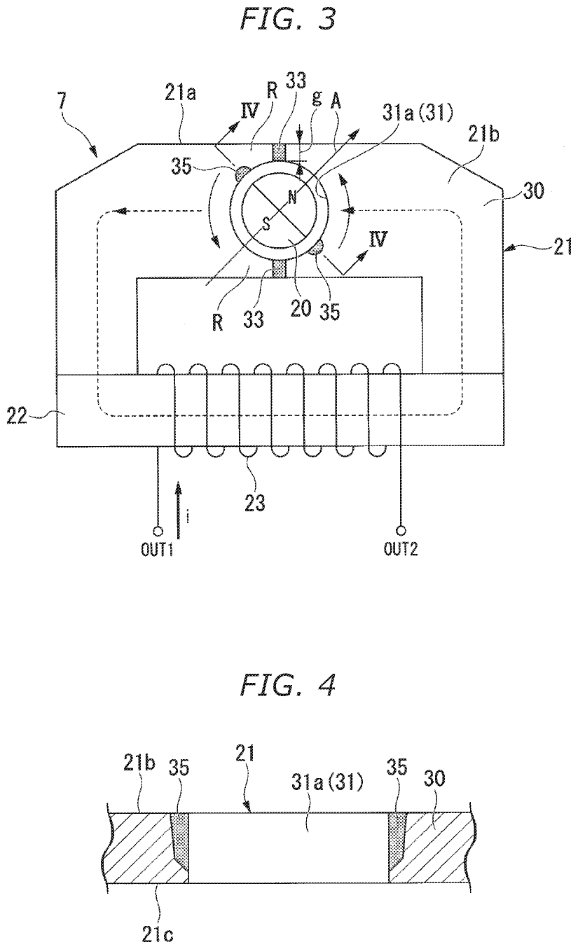

FIG. 3 is a plan view schematically illustrating the stepping motor according to the first embodiment.

As illustrated in FIG. 3, the stator 21 extends to be connected to both end portions of the magnetic core 22. The stator 21 is a plate-shaped magnetic body 30 formed of a magnetic material except for a magnetoresistive portion 33 and a non-magnetic portion 35 (to be described later). In the present embodiment, a Cr alloy containing Fe-38% and Ni-8% (so-called 38 permalloy) is used as the magnetic material. A through-hole 31 for locating the rotor 20 is formed in an intermediate portion of the magnetic body 30 of the stator 21. The term “intermediate” used in the present embodiment means that not only a center between both ends of an object but also an inner range between both ends of the object is included. The through-hole 31 penetrates the magnetic body 30 of the stator 21 in a thickness direction thereof. The through-hole 31 is formed in a circular shape having a constant curvature over the entire periphery when viewed in the thickness direction of the magnetic body 30 of the stator 21. The through-hole 31 is formed coaxially with the rotor 20, and has a larger diameter than the rotor 20.

The stator 21 includes a magnetic path R, a pair of magnetoresistive portions 33, and a pair of non-magnetic portions 35.

The magnetic path R is disposed in the magnetic body 30 around the through-hole 31. A magnetic flux line of the magnetic field generated by exciting the coil 23 passes through the magnetic path R. The magnetic path R is the magnetic body 30 between the through-hole 31 and an outer edge 21a of the stator 21. That is, the magnetic paths R are respectively disposed on both sides across the through-hole 31 in a direction orthogonal to an extending direction of the stator 21.

The pair of magnetoresistive portion 33 generates a magnetic pole around the through-hole 31 in a case where the coil 23 is excited. The pair of magnetoresistive portion 33 is disposed one by one in each magnetic path R. The pair of magnetoresistive portions 33 is disposed at two locations around the through-hole 31 where a cross-sectional area of the magnetic path R is minimized. That is, the pair of magnetoresistive portions 33 is disposed in a location where an interval between the through-hole 31 and the outer edge 21a of the stator 21 is narrow around the through-hole 31. For example, the pair of magnetoresistive portions 33 is disposed at positions shifted from each other by 180° around a rotation center of the rotor 20. The pair of magnetoresistive portions 33 increases magnetic resistance against the magnetic field generated from the coil 23, and generates a magnetic flux leakage inside the through-hole 31. The magnetic flux leakage occurs to be orthogonal to a line segment connecting the pair of magnetoresistive portions 33 to each other. In this manner, a magnetic pole is generated around the through-hole 31.

In the present embodiment, the magnetoresistive portion 33 is formed of a non-magnetic material. The magnetoresistive portion 33 is formed by means of non-contact processing using thermal melting. Specifically, the magnetoresistive portion 33 according to the present embodiment is formed so that Cr is melted and diffused in the magnetic body 30 for forming the stator 21. In this manner, a Cr content rate is higher than that of the magnetic body 30. In this manner, the magnetoresistive portion 33 is formed to have lower magnetic permeability than the magnetic body 30, and increases the magnetic resistance against the magnetic field generated from the coil 23. For example, it is desirable that a maximum value of Cr concentration in the magnetoresistive portion 33 is 15% by mass to 80% by mass, from a viewpoint of reducing the magnetic permeability of the magnetoresistive portion 33. The Cr concentration in the magnetoresistive portion 33 increases from the second main surface 21c side toward the first main surface 21b side of the stator 21. The pair of magnetoresistive portions 33 is continuously disposed from the through-hole 31 throughout the outer edge 21a of the stator 21 on at least the first main surface 21b of the stator 21. A minimum interval g from the through-hole 31 to the outer edge 21a of the stator 21 in the magnetoresistive portion 33 is 0.1 mm or longer.

The pair of non-magnetic portions 35 is disposed at positions different from the pair of magnetoresistive portions 33 around the through-hole 31. For example, the pair of non-magnetic portions 35 is disposed at positions shifted from each other by 180° around the rotation center of the rotor 20. For example, the pair of non-magnetic portions 35 is disposed so that a line segment connecting the pair of non-magnetic portions 35 to each other is inclined in the forward rotation direction of the rotor 20 by a predetermined angle with respect to a line segment connecting the pair of magnetoresistive portions 33 to each other.

The non-magnetic portion 35 is formed of a non-magnetic material. The non-magnetic portion 35 is formed by means of non-contact processing using thermal melting. Specifically, in the non-magnetic portion 35 according to the present embodiment Cr is melted and diffused in a magnetic plate material forming the stator 21. In this manner, the Cr content rate is higher than that of the magnetic body 30. In this manner, the non-magnetic portion 35 is formed to have the lower magnetic permeability than the magnetic body 30, thereby increasing magnetic resistance of the location, compared to a case where the non-magnetic portion 35 is not disposed therein. For example, it is desirable that the maximum value of the Cr concentration in the non-magnetic portion 35 is 15% by mass to 80% by mass, from a viewpoint of reducing the magnetic permeability of the non-magnetic portion 35. Similarly to the magnetoresistive portion 33, the Cr concentration in the non-magnetic portion 35 increases from the second main surface 21c side toward the first main surface 21b side of the stator 21.

The non-magnetic portion 35 is formed in a semicircular shape on the first main surface 21h of the stator 21. The non-magnetic portion 35 is disposed on an inner peripheral surface 31a of the through-hole 31 (refer to FIG. 4). That is, a portion of the non-magnetic portion 35 configures the inner peripheral surface 31a of the through-hole 31.

The pair of non-magnetic portions 35 is configured to serve as a positioning portion for determining a static position of the rotor 20 in a state where the coil 23 is not excited. The rotor 20 is static at a position where magnetic force attraction is strongest. The non-magnetic portion 35 is formed so that the magnetic permeability is reduced compared to the surrounding region. Accordingly, the rotor 20 is static at a position where the magnetic pole of the rotor 20 does not face the non-magnetic portion 35. In other words, the pair of non-magnetic portions 35 generates a difference in the magnetic potentials of the rotor 20 depending on a rotation position of the rotor 20. The rotor 20 is static at a position where the magnetic potential is minimized. The holding torque acts on the rotor 20 so that the rotor 20 stays at the position. For example, the rotor 20 is static at a position where a magnetic pole axis A of the rotor 20 is orthogonal to a line segment connecting the pair of non-magnetic portions 35 to each other.

FIG. 4 is a sectional view of the stator which is taken along line IV-IV in FIG. 3.

As illustrated in FIG. 4, the non-magnetic portion 35 is formed so that a cross-sectional area of a cross section orthogonal to a thickness direction of the stator 21 gradually decreases from the first main surface 21b toward the second main surface 21c of the stator 21. In the present embodiment, the non-magnetic portion 35 is disposed only in a portion of the stator 21 in the thickness direction. Specifically, the non-magnetic portion 35 is formed not to reach the second main surface 21c from the first main surface 21b of the stator 21, and does not penetrate the magnetic body 30.

### Manufacturing Method of Stator

Next, a manufacturing method of the stator according to the first embodiment will be described.

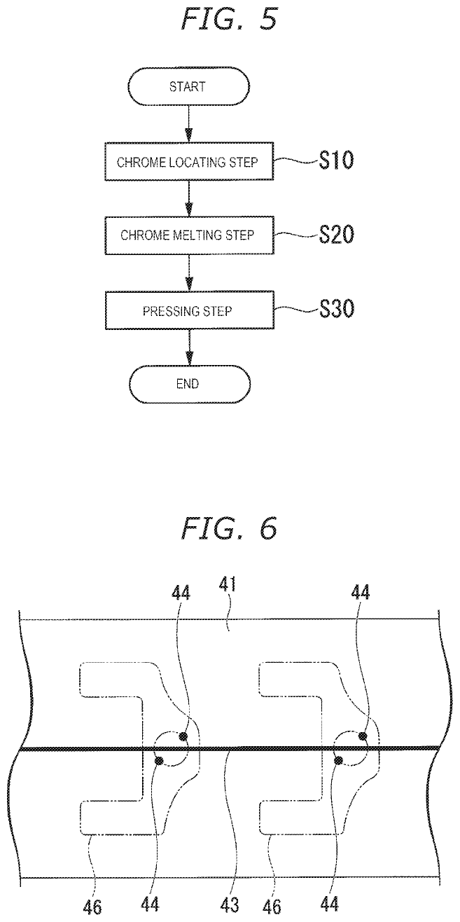

FIG. 5 is a flowchart illustrating the manufacturing method of the stator according to the first embodiment. FIG. 6 is a schematic view for describing the manufacturing method of the stator according to the first embodiment. In FIG. 6, a reference numeral 46 indicates a shear position for press working.

As illustrated in FIG. 5, the manufacturing method of the stator 21 according to the present embodiment includes a chrome locating step S10, a chrome melting step S20, and a pressing step S30 (through-hole forming step).

As illustrated in FIG. 6, in the chrome locating step S10, a Cr material is located on a surface of a magnetic plate material 41 (magnetic material) forming the stator 21. For example, as the magnetic plate material 41, Cr containing Fe-38% and Ni-8% (so-called 38 permalloy) can be used. For example, the Cr material is located on the magnetic plate material 41 in such a way that a paste is applied to the magnetic plate material 41 by using a dispenser and then drying the Cr material. The location of the Cr material is not limited to the paste application, and for example, plating on the magnetic plate material 41 may be applied.

In the chrome melting step S20, the Cr material is irradiated with laser so that the Cr material is melted and solidified in the magnetic plate material 41. Specifically, the Cr material located on the surface of the magnetic plate material 41 is irradiated with the laser. The Cr material is dissolved in the magnetic plate material 41 which is a base material. In this manner, the Cr material is melted and diffused in the magnetic plate material 41, thereby forming Cr diffusion regions 43 and 44 in which a Cr weight ratio locally increases. The Cr diffusion regions 43 and 44 are formed at positions corresponding to the magnetoresistive portion 33 and the non-magnetic portion 35 of the stator 21. The Cr diffusion region 43 is formed for use in the magnetoresistive portion 33, and is formed in a continuous linear shape, for example. The Cr diffusion region 44 is formed for use in the non-magnetic portion 35, and is locally formed only at a position corresponding to the non-magnetic portion 35. Thereafter, in order to remove an unnecessary Cr material, the magnetic plate material 41 obtained by melting and solidifying the Cr material is cleaned if necessary.

A range of the Cr diffusion regions 43 and 44 varies depending on the amount of heat applied by the laser irradiation. As the amount of applied heat increases, a depth for melting and diffusing Cr increases. That is, the range of the Cr diffusion regions 43 and 44 can be set to any desired depth by adjusting an output and an irradiation time, or an opening size of the laser. For example, the Cr diffusion regions 43 and 44 can be formed to reach the second main surface from the first main surface of the magnetic plate material 41, and can be formed no to reach the second main surface from the first main surface of the magnetic plate material 41. In the present embodiment, the Cr diffusion regions 43 and 44 are formed not to reach the second main surface from the first main surface of the magnetic plate material 41.

The pressing step S30 is performed after the chrome melting step S20. In the pressing step 530, the magnetic plate material 41 in which Cr is melted and solidified is punched to form an outer shape of the stator 21 and the through-hole 31. In this case, the magnetic plate material 41 is sheared to cross the Cr diffusion regions 43 and 44.

According to above-described configuration, the stator 21 including the magnetoresistive portion 33 and the non-magnetic portion 35 is formed.

The magnetic potential of the above-described rotor 20 varies depending on magnetic permeability, a size, or a position of the pair of non-magnetic portions 35. That is, the holding torque acting on the rotor 20 which is static can be adjusted by adjusting the depth of the Cr diffusion region 44 formed in the chrome melting step S20.

### Operation of Stepping Motor

Next, an operation of the stepping motor according to the first embodiment will be described.

As illustrated in FIG. 3, in a case where no current flows through the coil 23, the rotor 20 is static at a position where the magnetic potential is minimized.

If a current i is caused to flow in an arrow direction in FIG. 3 by supplying a drive pulse signal from the pulse drive circuit 6 to between terminals OUT1 and OUT2 of the coil 23 (for example, a first terminal OUT1 side is set to a positive pole and a second terminal OUT2 side is set to a negative pole), a magnetic flux is generated in the stator 21 in a broken arrow direction.

In the present embodiment, the magnetoresistive portion 33 is formed in a magnetic path R. Therefore, a magnetic flux leakage can be easily secured inside the through-hole 31. Thereafter, due to an interaction between the magnetic pole generated in the stator 2.1 and the magnetic pole of the rotor 20, the rotor 20 is rotated 180° in the arrow direction in FIG. 3, and is stably stopped (static).

A rotation direction (counterclockwise direction in FIG. 3) for performing a normal operation (for example, a hand operation of an analog electronic timepiece) by rotationally driving the stepping motor 7 is set as a forward rotation direction, and a direction opposite thereto (clockwise direction) is set as a rearward rotation direction.

Next, if the current is caused to flow in the opposite arrow direction in FIG. 3 by supplying a drive pulse having a reverse polarity from the pulse drive circuit 6 to the terminals OUT1 and OUT2 of the coil 23, the magnetic flux is generated in the stator 21 in the direction opposite to the broken arrow direction.

Thereafter, as described above, due to the interaction between the magnetic pole generated in the stator 21 and the magnetic pole of the rotor 20, the rotor 20 is rotated 180° in the same direction (forward rotation direction), and is stably stopped (static).

Thereafter, in this way, signals having different polarities (alternating signals) are supplied to the coil 23. In this manner, the above-described operation is repeatedly performed, and the rotor 20 can be continuously rotated every 180° in the arrow direction.

As described above, the stator 21 according to the present embodiment includes the magnetoresistive portion 33 disposed around the through-hole 31 to generate the magnetic pole around the through-hole 31 in a case where the coil 23 is excited, and the non-magnetic portion 35 disposed at the position different from that of the magnetoresistive portion 33 around the through-hole 31 and formed to have the lower magnetic permeability than the magnetic body 30.

According to this configuration, the non-magnetic portion 35 having the lower magnetic permeability than the magnetic body 30 is disposed around the through-hole 31. In this manner, without providing the through-hole 31 with a notch or step shape, a difference in magnetic potentials of the rotor 20 can be generated depending on a rotation position of the rotor 20. Therefore, the holding torque acting on the rotor 20 can be adjusted by appropriately adjusting a shape, a size, or the magnetic permeability of the non-magnetic portion 35. Therefore, it is possible to provide the stator 21 which can reduce the holding torque acting on the rotor 20.

The non-magnetic portion 35 is disposed on the inner peripheral surface 31a of the through-hole 31. According to this configuration, the non-magnetic portion 35 can be disposed at a position directly facing the rotor 20. Therefore, the difference in the magnetic potentials of the rotor 20 can be reliably generated depending on the rotation position of the rotor 20. Therefore, it is possible to prevent an insufficient holding torque acting on the rotor 20.

The stator 21 is formed of the Ni—Fe alloy, and the non-magnetic portion 35 is formed so that the Cr content rate locally increases. According to this configuration, the magnetic permeability of the non-magnetic region is reduced compared to the surrounding region by the non-magnetic region which is brought into an austenitic single phase having diffused Cr. Accordingly, it is possible to form the non-magnetic portion 35 having the lower magnetic permeability than the magnetic body 30.

The non-magnetic portion 35 is disposed only in a portion of the through-hole 31 in the penetrating direction (that is, the thickness direction of the stator 21). According to this configuration, compared to a case where the non-magnetic portion is disposed over the entire region of the through-hole 31 in the penetrating direction, a range where the non-magnetic portion 35 is affected by the magnetic field of the rotor 20 is reduced. In this manner, it is possible to reduce the difference in the magnetic potentials of the rotor 20 depending on the rotation position of the rotor 20. That is, the holding torque acting on the rotor 20 can be adjusted by appropriately adjusting the range having the non-magnetic portion 35 in the penetrating direction of the through-hole 31.

The magnetoresistive portion 33 is formed to locally have the lower magnetic permeability, and a minimum interval from the through-hole 31 to the outer edge 21a of the stator 21 is 0.1 mm or longer. In the related art, in some cases, in order to generate the magnetic pole by magnetically dividing the stator, the interval from the through-hole to the outer edge of the stator is narrowed so that the magnetic flux density saturation is generated by the magnetic field of the coil. According to the present invention, the magnetic permeability of the magnetoresistive portion 33 is reduced compared to the magnetic body 30. In this manner, the magnetic pole can be generated by using the magnetoresistive portion 33 to magnetically divide the stator 21 without adopting the related art. Accordingly, the magnetic pole can be generated by the magnetoresistive portion 33, even if the minimum interval g from the through-hole 31 to the outer edge 21a of the stator 21 is set to 0.1 mm or longer. Compared to the related art, the strength of the stator 21 can be improved.

The manufacturing method of the stator 21 according to the present embodiment includes the chrome locating step S10 of locating the Cr material in the magnetic plate material 41, the chrome melting step S20 of melting and solidifying the Cr material in the magnetic plate material 41 by irradiating the Cr material with the laser, and the pressing step S30 of forming the through-hole 31 by punching the magnetic plate material 41 after the chrome melting step S20 is performed. According to this configuration, the through-hole 31 is formed after the Cr material is melted and solidified. Therefore, it is possible to prevent thermal deformation of the through-hole 31. Therefore, the stator 21 can be accurately formed.

The stepping motor 7 according to the present embodiment includes the above-described stator 21 and the rotor 20 located in the through-hole 31. The movement 17 according to the present embodiment includes the stepping motor 7, and the train wheel 11 that transmits the power of the stepping motor 7. According to the present embodiment, the stator 21 is provided which can reduce the holding torque acting on the rotor 20. Therefore, it is possible to reduce the current flowing through the coil 23 when the rotor 20 is rotated. Therefore, it is possible to reduce power consumption.

The timepiece 1 according to the present embodiment includes the above-described movement 17. Therefore, it is possible to provide the timepiece for which the power consumption is reduced. In particular, the configuration according to the present embodiment is preferably applicable to a timepiece having a small mountable battery.

### Second Embodiment

### Configuration of Stepping Motor

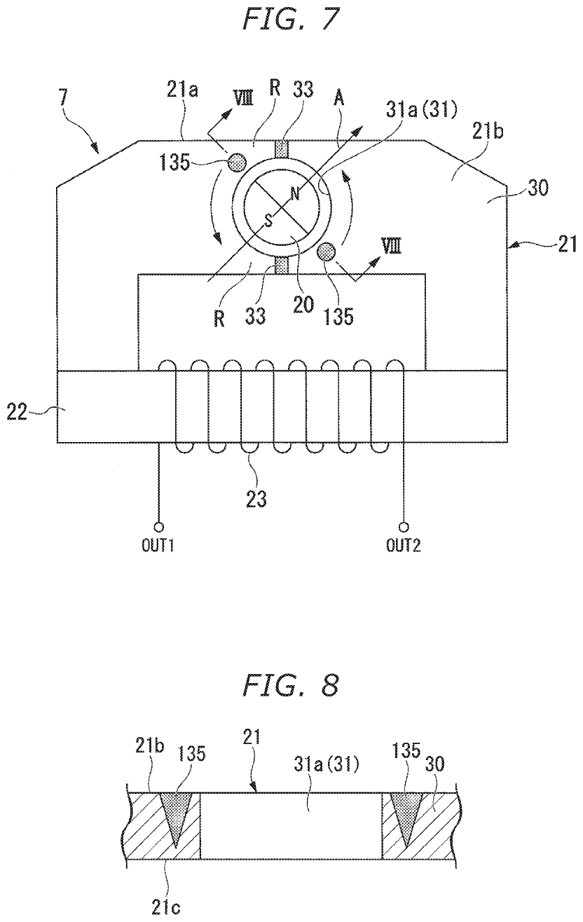

FIG. 7 is a plan view schematically illustrating a stepping motor according to a second embodiment. FIG. 8 is a sectional view of the stator which is taken along line in FIG. 7.

In the first embodiment illustrated in FIG. 3, the non-magnetic portion 35 is disposed on the inner peripheral surface 31a of the through-hole 31. In contrast, in the second embodiment illustrated in FIG. 7, a non-magnetic portion 135 is disposed away from the through-hole 31. In this regard, the second embodiment is different from the first embodiment. Configurations other than those described below are the same as those according to the first embodiment.

As illustrated in FIG. 7, the non-magnetic portion 135 is formed in a circular shape on the first main surface 21b of the stator 21.

As illustrated in FIG. 8, the non-magnetic portion 135 is formed so that a cross-sectional area of a cross section orthogonal to the thickness direction of the stator 21 gradually decreases from the first main surface 21b toward the second main surface 21c of the stator 21. In the present embodiment, the non-magnetic portion 135 is disposed only in a portion of the stator 21 in the thickness direction. Specifically, the non-magnetic portion 135 is formed not to reach the second main surface 21c from the first main surface 21b of the stator and does not penetrate the magnetic body 30. The minimum interval between the non-magnetic portion 135 and the through-hole 31 is 0.1 mm or shorter, for example.

As described above, according to the present embodiment of the stator 21, the non-magnetic portion 135 is disposed in the range affected by the magnetic field of the rotor 20. Therefore, a difference in the magnetic potentials of the rotor 20 can be generated depending on the rotation position of the rotor 20. Therefore, it is possible to provide the stator 21 which can achieve the same operational effects as those of the above-described first embodiment.

### Third Embodiment

### Configuration of Stepping Motor

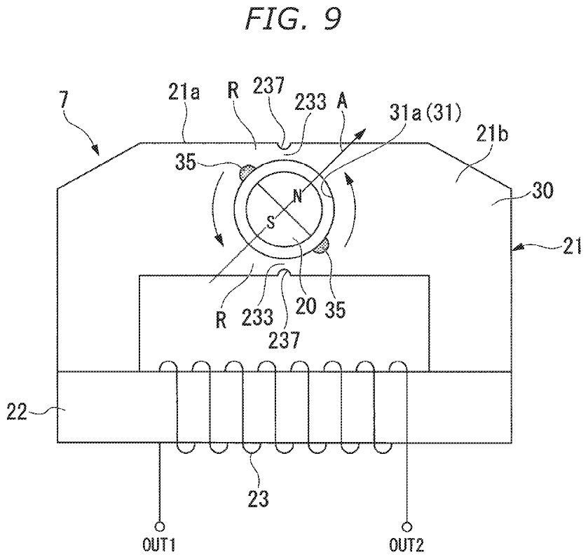

FIG. 9 is a plan view schematically illustrating a stepping motor according to a third embodiment.

According to the first embodiment illustrated in FIG. 3, the magnetoresistive portion 33 is formed to have the lower magnetic permeability than the magnetic body 30. In contrast, according to the third embodiment illustrated in FIG. 9, a magnetoresistive portion 233 is a narrow portion formed by disposing an outer notch 237 in the outer edge 21a of the stator 21. In this regard, the third embodiment is different from the first embodiment. Configurations other than those described below are the same as those according to the first embodiment.

As illustrated in FIG. 9, the pair of outer notches 237 is formed in the outer edge 21a of the stator 21. Each of the pair of outer notches 237 is disposed on a side opposite to the through-hole 31 across the magnetic path R The outer notch 237 locally reduces a cross-sectional area of the magnetic path R.

The pair of magnetoresistive portion 233 is disposed between the outer notch 237 and the through-hole 31 in the magnetic path R. The pair of magnetoresistive portions 233 is disposed in two locations around the through-hole 31 in which the cross-sectional area of the magnetic path R is minimized. The magnetoresistive portion 233 is integrally formed using the same member as that of the surrounding region. That is, the magnetoresistive portion 233 is formed of a magnetic material. The pair of magnetoresistive portions 233 is formed so that the magnetic flux is not saturated by the magnetic field of the rotor 20 and the magnetic flux is saturated when the coil 23 is excited. In this manner, the pair of magnetoresistive portions 233 increase magnetic resistance against the magnetic field generated from the coil 23, and generates the magnetic flux leakage inside the through-hole 31, thereby generating the magnetic pole around the through-hole 31.

As described above, according to the stator 21 of the present embodiment, it is possible to achieve the same operational effects as those of the stator 21 according to the above-described first embodiment.

### Fourth Embodiment

### Configuration of Stepping Motor

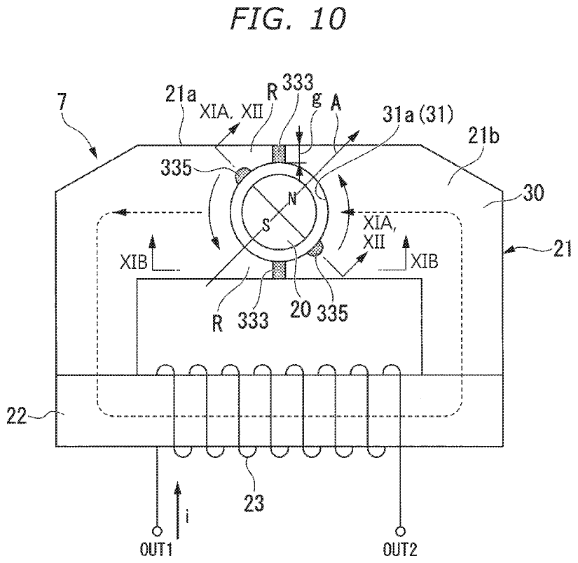

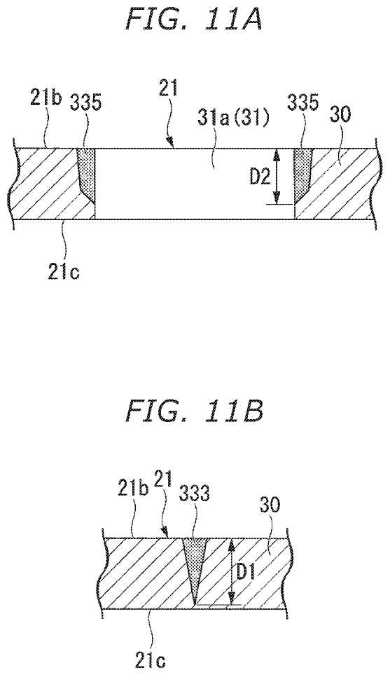

FIG. 10 is a plan view schematically illustrating a stepping motor according to a fourth embodiment. FIGS. 11A and 11B are sectional views of the stator according to the fourth embodiment. FIG. 11A is a sectional view of the stator which is taken along line XIA-XIA in FIG. 10, and FIG. 11B is a sectional view of the stator which is taken along line XIB-XIB in FIG. 10.

According to the first embodiment and the second embodiment, the respective depths of the magnetoresistive portion 33 and the non-magnetic portions 35 and 135 are not particularly limited. In contrast, according to the fourth embodiment illustrated in FIG. 10, depths of a magnetoresistive portion 333 and a non-magnetic portion 335 are different from each other. Configurations other than those described below are the same as those according to the first embodiment.

As illustrated in FIGS. 10, 11A, and 11B, the magnetoresistive portion 333 is formed so that a cross-sectional area of a cross section orthogonal to the thickness direction of the stator 21 gradually decreases from the first main surface 21b toward the second main surface 21c of the stator 21. The magnetoresistive portion 333 is disposed only in a portion of the stator 21 in the thickness direction. Specifically, the magnetoresistive portion 333 is formed not to reach the second main surface 21c from the first main surface 21b of the stator 21, and does not penetrate the magnetic body 30. The magnetoresistive portion 333 is formed to reach a first depth D1 from the first main surface 21b (first surface of the magnetic body 30) of the stator 21.

The non-magnetic portion 335 is formed so that a cross-sectional area of a cross section orthogonal to the thickness direction of the stator 21 gradually decreases from the first main surface 21b toward the second main surface 21c of the stator 21. The non-magnetic portion 335 is disposed only in a portion of the stator 21 in the thickness direction. Specifically, the non-magnetic portion 335 is formed not to reach the second main surface 21c from the first main surface 21b of the stator 21, and does not penetrate the magnetic body 30. The non-magnetic portion 335 is formed to reach a second depth D2 different from the first depth D1 from the first main surface 21b of the stator 21. The second depth D2 is shallower than the first depth D1. That is, the non-magnetic portion 335 is formed to be shallower than the magnetoresistive portion 333, based on the first main surface 21b of the stator 21.

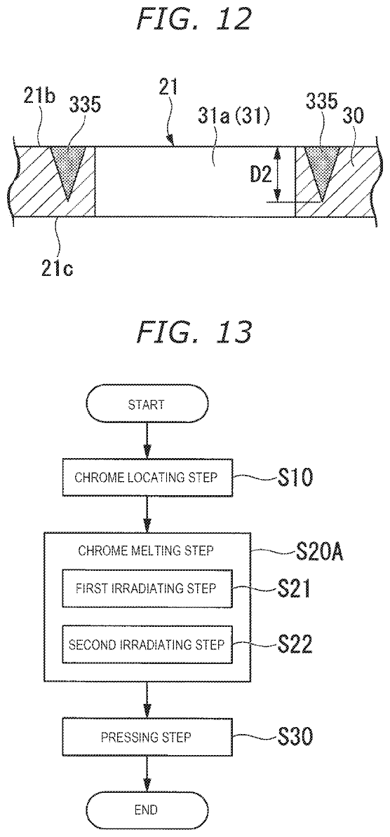

In the illustrated example, the non-magnetic portion 335 is disposed on the inner peripheral surface 31a of the through-hole 31, as in the non-magnetic portion 35 according to the first embodiment. However, as illustrated in FIG. 12, the non-magnetic portion 335 may be disposed away from the through-hole 31, as in the non-magnetic portion 135 of the second embodiment.

### Manufacturing Method of Stator

Next, a manufacturing method of a stator according to a fourth embodiment will be described with reference to FIGS. 6 and 12.

FIG. 13 is a flowchart illustrating the manufacturing method of the stator according to the fourth embodiment.

As illustrated in FIG. 13, in the manufacturing method of the stator 21 according to the present embodiment, a chrome melting step S20A has a first irradiating step S21 and a second irradiating step S22. A sequence of the first irradiating step S21 and the second irradiating step S22 is not particularly limited.

In the first irradiating step S21, the Cr material is irradiated with the laser so as to form the Cr diffusion region 43 which is a portion of the magnetoresistive portion 333.

In the second irradiating step S22, the Cr material is irradiated with the laser so as to form the Cr diffusion region 44 which is at least a portion of the non-magnetic portion 335. In the second irradiating step S22, energy lower than energy of the laser in the first irradiating step S21 is applied to the Cr material and the magnetic plate material 41. In this manner, the depth for melting and diffusing Cr in the Cr diffusion region 44 is shallower than the depth for melting and diffusing Cr in the Cr diffusion region 43.

The energy applied by the laser can be changed by adjusting at least one of an output and an irradiation time of the laser. The output of the laser can be changed by adjusting pulse energy of pulse laser, a frequency of a pulse, and an opening size of the laser. In adjusting the opening size of the laser, it is necessary to change mechanical settings of a laser device or to replace the existing lens with a new lens having a different opening size between the first irradiating step S21 and the second irradiating step S22.

Therefore, from a viewpoint of reducing production costs such as improving productivity, it is desirable to change the energy applied by the laser only by using a method which can correspond to only changing an output condition of the laser. That is, it is desirable to change the energy applied by the laser by adjusting the pulse energy, the pulse frequency, and the irradiation time.

According to the stator 21 of the fourth embodiment described above, the following operational effects can be achieved in addition to the operational effects similar to those of the above-described first embodiment.

In the present embodiment, the non-magnetic portion 335 does not penetrate the magnetic body 30. According to this configuration, compared to a case where the non-magnetic portion penetrates the magnetic body, it is possible to reduce a range in which the non-magnetic portion 335 is affected by the magnetic field of the rotor 20. Therefore, a maximum value of the magnetic potential decreases in a relationship between the rotation position of the rotor 20 and the magnetic potential. Therefore, it is possible to prevent the excessive holding force acting on the rotor 20.

The magnetoresistive portion 333 is formed to reach the first depth D1 from the first main surface 21b of the stator 21, and the non-magnetic portion 335 is formed to reach the second depth D2 different from the first depth D1 from the first main surface 21b of the stator 21. According to this configuration, the magnetoresistive portion 333 and the non-magnetic portion 335 are formed to have mutually different depths. Here, from a viewpoint of preventing the excessive magnetic flux required for the magnetic saturation when the magnetic pole is generated, it is desirable to appropriately set the depth of the magnetoresistive portion 333. From a viewpoint of preventing the excessive holding force acting on the rotor 20, it is desirable to appropriately set the depth of the non-magnetic portion 335. The magnetoresistive portion 333 and the non-magnetic portion 335 are formed to have the mutually different depths. In this manner, it is possible to prevent the excessive magnetic flux when the magnetic pole is generated, and to prevent the excessive holding force acting on the rotor 20. Therefore, it is possible to reduce a current flowing through the coil 23 when the rotor 20 is rotated.

Furthermore, the second depth D2 is shallower than the first depth D1. According to this configuration, while the depth of the non-magnetic portion 335 is set in order to obtain a desired holding force acting on the rotor 20, compared to the non-magnetic portion 335, the magnetoresistive portion 333 can be deeply formed to reduce the magnetic flux required for the magnetic saturation. Accordingly, it is possible to prevent the excessive magnetic flux when the magnetic pole is generated, and to prevent the excessive holding force acting on the rotor 20. Therefore, it is possible to reduce the current flowing through the coil 23 when the rotor 20 is rotated.

According to the present embodiment, the chrome melting step S20A includes the first irradiating step S21 for forming at least a portion of the magnetoresistive portion 333 by irradiating the Cr material with the laser, and the second irradiating step S22 for forming at least a portion of the non-magnetic portion 335 by irradiating the Cr material with the laser and applying the energy lower than the energy of the laser in the first irradiating step S21. According to this configuration, as the applied energy increases, the depth for melting and diffusing Cr increases. Accordingly, the non-magnetic portion 335 can be formed to be shallower than the magnetoresistive portion 333. Therefore, while the excessive magnetic flux is prevented when the magnetic pole is generated around the magnetoresistive portion 333, it is possible to prevent the excessive holding force acting on the rotor 20. Therefore, it is possible to provide the stator which can reduce the current flowing through the coil 23 when the rotor 20 is rotated.

In the fourth embodiment, the magnetoresistive portion 333 and the non-magnetic portion 335 are formed to have the mutually different depths by changing the energy applied by the laser. However, the present invention is not limited thereto. For example, the depth of the non-magnetic portion 335 may be made different from the depth of the magnetoresistive portion 333 by adjusting the position of the Cr diffusion region 44 with respect to a shear position of the through-hole 31.

The present invention is not limited to the embodiments described above with reference to the drawings, and it is conceivable to adopt various modifications within a technical scope thereof.

For example, according to the above-described embodiment, the stepping motor 7 is a single coil motor including one coil 23. However, the present invention is not limited thereto. The stepping motor may be a double coil motor including two coils.

According to the above-described embodiment, in a plan view, the non-magnetic portions 35 and 135 are formed in a circular shape. However, the present invention is not limited thereto. In the plane view, the shape of the non-magnetic portion may correspond to an irradiation range of the laser, and may be appropriately adjusted in order to control the holding torque acting on the rotor 20. That is, in the plane view, the shape of the non-magnetic portion may be an elliptical shape or an oval shape (rounded rectangular shape), for example.

According to the above-described embodiment, the magnetoresistive portion 33 is formed of the non-magnetic material, and is continuously disposed from the through-hole 31 to the outer edge 21a of the stator 21. However, the present invention is not limited thereto. In a case where the magnetoresistive portion is formed of the non-magnetic material, the magnetoresistive portion may be disposed in at least a portion between the through-hole 31 and the outer edge 21a of the stator 21.

According to the above-described embodiment, the non-magnetic portions 35 and 135 are disposed only in a portion of the through-hole 31 in the penetrating direction. However, the present invention is not limited thereto. The non-magnetic portion may be disposed over the entire region of the through-hole 31 in the penetrating direction, and may reach the second main surface 21c from the first main surface 21b of the stator 21.

According to the above-described embodiment, the pair of non-magnetic portions 35 and 135 is provided. However, the present invention is not limited thereto. Only one non-magnetic portion may be provided. Alternatively, three or more non-magnetic portions may be provided.

With regard to the through-hole belonging to the magnetic body 30, the through-hole 31 may not be formed in the magnetic body 30 as a whole. That is, at least a portion of the through-hole may be formed in the magnetic body. For example, the magnetic body may be divided by the magnetoresistive portion 33 so as to form only a portion of the inner peripheral surface of the through-hole. In this case, the same operational effects as those according to the above-described embodiments can also be achieved.

Alternatively, configuration elements according to the above-described embodiments can be replaced with well-known configuration elements within the scope not departing from the gist of the present invention. In addition, the above-described embodiments may be appropriately combined with each other.

What is claimed is:

1. A stator comprising:
a magnetic body having a through-hole;
a magnetoresistive portion disposed around the through-hole to generate a magnetic pole around the through-hole in a case where a coil is excited; and
a non-magnetic portion disposed at a position different from a position of the magnetoresistive portion around the through-hole by means of thermal melting, and formed to have lower magnetic permeability than the magnetic body.

2. The stator according to claim 1,
wherein the non-magnetic portion is disposed on an inner peripheral surface of the through-hole.

3. The stator according to claim 1,
wherein the non-magnetic portion is disposed away from the through-hole.

4. The stator according to claim 1,
wherein the non-magnetic portion is disposed in only a portion of the through-hole in a penetrating direction.

5. The stator according to claim 4,
wherein the non-magnetic portion does not penetrate the magnetic body.

6. The stator according to claim 1,
wherein the magnetic body includes a Ni—Fe alloy, and the non-magnetic portion is formed to have a higher Cr content rate than the magnetic body.

7. The stator according to claim 6,
wherein the magnetoresistive portion is formed by means of the thermal melting, and is formed to have the lower magnetic permeability than the magnetic body and to have the higher Cr content rate than the magnetic body.

8. The stator according to claim 7,
wherein the magnetoresistive portion is formed to reach a first depth from a first surface of the magnetic body, and
wherein the non-magnetic portion is formed to reach a second depth different from the first depth from the first surface of the magnetic body.

9. The stator according to claim 8,
wherein the second depth is shallower than the first depth.

10. The stator according to claim 1,
wherein the magnetoresistive portion is formed to have the lower magnetic permeability than the magnetic body, and a minimum interval from the through-hole to an outer edge of the stator is 0.1 mm or longer.

11. A stepping motor comprising:
the stator according to claim 1; and
a rotor located in the through-hole.

12. A timepiece movement comprising:
the stepping motor according to claim 11; and
a train wheel that transmits power of the stepping motor.

13. A timepiece comprising:
the timepiece movement according to claim 12.

14. A manufacturing method of a stator including
a magnetic body having a through-hole and including a Ni—Fe alloy,
a magnetoresistive portion disposed around the through-hole to generate a magnetic pole around the through-hole in a case where a coil is excited, and
a non-magnetic portion disposed at a position different from a position of the magnetoresistive portion around the through-hole, and formed to have lower magnetic permeability than the magnetic body,
the manufacturing method comprising:
locating a Cr material in a magnetic material;
melting and solidifying the Cr material in the magnetic material by irradiating the Cr material with a laser; and
forming the through-hole by punching the magnetic material after the Cr material is melted.

15. The manufacturing method of the stator according to claim 14,
wherein the chrome melting step includes
a first irradiating step of forming at least a portion of the magnetoresistive portion by irradiating the Cr material with the laser, and
a second irradiating step of forming at least a portion of the non-magnetic portion by irradiating the Cr material with the laser and applying energy lower than energy of the laser used in the first irradiating step.
